(19) United States
(12) Patent Application Publication
(10) Pub. No.: US 2004/0256497 A1
(43) Pub. Date: Dec. 23, 2004

(54) High performance nozzle

(76) Inventor: Douglas Allan Sharkey, Mt. Hood, OR (US)

Correspondence Address: GLENN C. BROWN, PC, 777 NW WALL STREET, SUITE 308, BEND, OR, 97701, US

(21) Appl. No.: 10/861,808

(22) Filed: Jun. 3, 2004

Related U.S. Application Data
(60) Provisional application No. 60/476,760, filed on Jun. 6, 2003.

(51) Int. Cl. B05B 1/30

(52) U.S. Cl. 239/569

(57) ABSTRACT

What is new about this nozzle is its ability to extend the reach of a fluid stream from a pressurized hose by means of low-friction design and nozzle aperture extension. The combination of low friction design and aperture extension produces an effect which is superior to that which might be anticipated by adding an extension to a hose. The nozzle is made of strong, lightweight, rigid materials. The extended stream reach exceeds the length of the long nozzle itself.

### CROSS-REFERENCE TO RELATED APPLICATION

This application is a continuation-in-part of U.S. provisional patent application No. 60/476,760, filed on Jun. 6, 2003. The priority of the prior application is expressly claimed and its disclosure is hereby incorporated by reference in its entirety.

### BACKGROUND OF THE INVENTION

While it is desirable to extinguish fires as quickly as possible, the safety of the firefighter is also a concern. The costs of fire suppression and the losses incurred from fire affect individuals, families, communities, local and national governments, and the public at large. Therefore, it is desirable to minimize the costs of fire suppression and the losses incurred from fire while also maximizing the safety of the firefighters.

### SUMMARY OF THE INVENTION

One object of this invention is to increase the efficiency, safety and function of a firefighting hose system.

Another object of this invention is to provide a device that significantly increases the stream reach of a pressurized hose nozzle.

A further object of this invention is to provide a device that maintains a safe working distance between the fire and the firefighter.

A still further object of this invention is to achieve the best function in expelling fluid to the greatest height and distance in conjunction with ease of use, safety, portability and durability.

A lightweight long nozzle is provided for attachment to a pressurized hose. The long nozzle is easily human-portable and usable. The long nozzle provides a significant increase in the throw-range of a water or fluid stream as compared to that of a conventional nozzle. This long nozzle is the solution to the firefighter's problem of how to most effectively propel water or foam solution to where it is most beneficial for firefighting, while at the same time still maintaining a safe working distance between the fire and the firefighter. The increased reach of this long nozzle will provide dramatic benefit in capability, efficacy, speed and safety of fire suppression efforts, thus resulting in significantly reduced fire damage to homes, personal property, forests and natural resources.

The above-stated objects of the invention are accomplished by a combination of rigid extension and the creation of an area of least possible friction immediately upstream of the critical fluid acceleration zone at the nozzle aperture. The friction reduction is achieved because the device has no longitudinal bending for the full length of the long nozzle, because it has very low-friction interior surfaces to maintain fluid velocity, and is designed so that mechanical sources of turbulence and friction, such as the hose coupling and shutoff valve are not in close proximity to the fluid acceleration zone near the nozzle aperture. The combination of low friction design and aperture extension produces unexpected results which are superior to that which might be anticipated by adding an extension to a hose.

### BRIEF DESCRIPTION OF THE DRAWINGS

The nature, principle and utility of the present invention will be clearly understood from the following detailed description when read in conjunction with the accompanying drawings, wherein:

FIG. 1A is a long nozzle according to a first embodiment of the invention.

FIG. 1B is a cross-sectional view of FIG. 1A.

FIG. 2 is a long nozzle according to a second embodiment of the invention.

FIG. 3 is a long nozzle according to a third embodiment of the invention.

FIG. 4A is a long nozzle according to a fourth embodiment of the invention.

FIG. 4B is a cross-sectional view of FIG. 4A.

FIG. 5 is a long nozzle according to a fifth embodiment of the invention.

FIG. 6 is a long nozzle according to a sixth embodiment of the invention.

FIGS. 7-10 are graphs illustrating the advantages of the long nozzle.

The drawings are for illustrative purposes only and are not drawn to scale. In the drawings, the same numbers are used for the same part or portion throughout the drawings.

### DETAILED DESCRIPTION OF THE PREFERRED EMBODIMENTS

The long nozzle is a very long, lightweight, durable and rigid nozzle that comprises a coupling device and a replaceable nozzle tip. The coupling device and the replaceable nozzle tip can be varied as to aperture/diameter, spray pattern, or air-aspirating (in the use of foam). The long nozzle may comprise a full-flow, ball-type shutoff valve. Alternatively, the long nozzle is designed to attach to an existing shutoff valve or nozzle thread. The long nozzle may also comprise a foam solution induction tee.

The long-nozzle may be manufactured from plastics, composites and/or metals. Preferably, the long nozzle is manufactured from plastics, thereby making the long nozzle more lightweight. In addition, plastics are less electrically conductive, and therefore, safer than metals. Components of the long nozzle are assembled by means of injection molding, extrusion, pultrusion, lamination, casting, machining, material-appropriate glues and/or friction-fit threading. The length of the long nozzle is in the range of approximately 50 inches to 204 inches and the diameter of the long nozzle is in the range of approximately ⅜ inches to 3 inches. The long nozzle may additionally comprise a support leg for ease of operation.

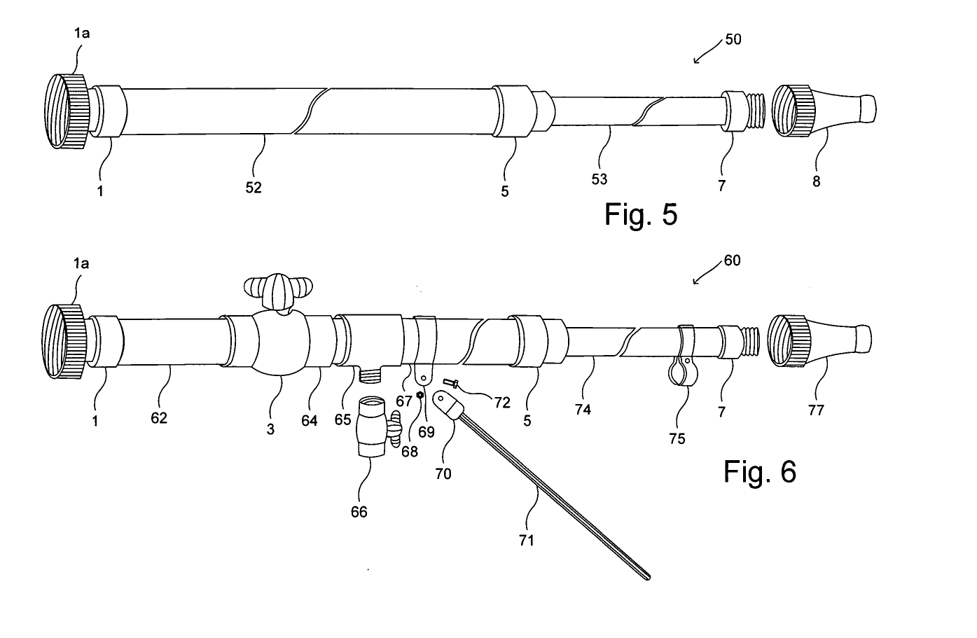

FIG. 5 shows the basic design of a long nozzle. Long nozzle 50 comprises an adapter 1 with rotating hose-coupling device la. Connected to the adapter 1 is a first pipe 52. A reducer coupling 5 attaches the first pipe 52 to a second pipe 53. The second pipe 53 has a smaller diameter than the first pipe 52. A ferrule 7 with external threads is attached to the second pipe 53. Finally, long nozzle 50 comprises a tapered straight steam nozzle tip 8 with internal threads.

To make the long nozzle more easily portable, the components of long nozzle 50 are preferably made of thermoplastic and are preferably assembled by gluing. Alternatively, the components of the long nozzle 50 may be made of any other known material, including, but not limited to, anodized aluminum, brass, and fiber-reinforced plastic. The length of the long nozzle 50 is in the range of 50 inches to 204 inches. Preferably, the length of long nozzle 50 is approximately 83.5 inches. The lengths, diameters and other dimensions of the individual components are variable.

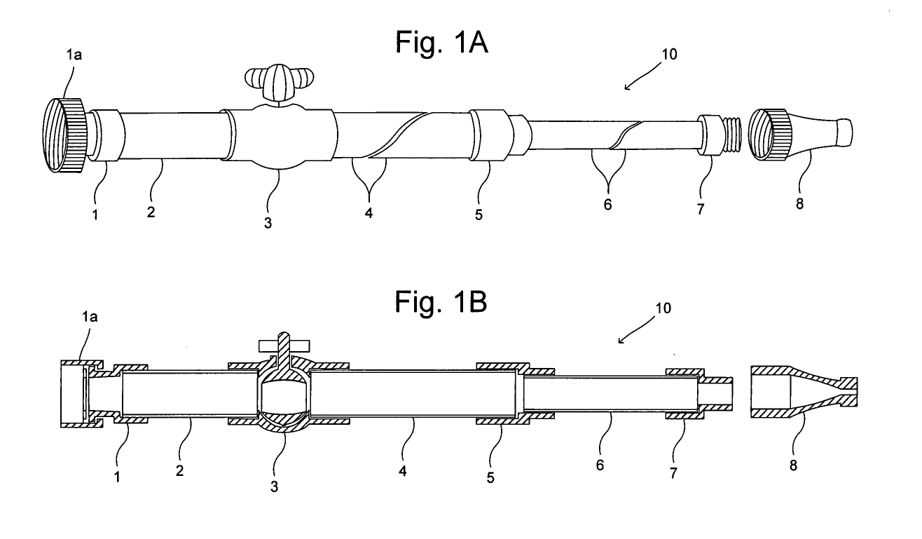

FIGS. 1A and 1B show a long nozzle 10 that is similar to the long nozzle 50 shown in FIG. 5, except that long nozzle 10 comprises a ball valve 3. Long nozzle 10 comprises an adapter 1 with rotating hose-coupling device la. Connected to the adapter 1 is a first pipe 2. The ball valve 3 is positioned between the first pipe 2 and the second pipe 4. A reducer coupling 5 is attached to the second pipe 4 on one side and to a third pipe 6 on the other side. A ferrule 7 with external threads is attached to the third pipe 6. Finally, long nozzle 10 comprises a tapered straight steam nozzle tip 8 with internal threads.

The components of long nozzle are preferably made of thermoplastic and are preferably assembled by gluing. Alternatively, the components of the long nozzle 10 may be made of any other known material, including, but not limited to, anodized aluminum, brass, and fiber-reinforced plastic. The lengths, diameters and other dimensions of the individual components are variable. In this example, the long nozzle 10 is approximately 98 inches long. The first pipe 2 and the second pipe 4 each have an outside diameter of about 1.31 inches and a wall thickness of about 0.125 inches. The first pipe 2 is preferably about 18 inches in length and the second pipe 4 is preferably about 26.5 inches in length. The third pipe 6 is about 48 inches in length and has an outside diameter of about 1.05 inches and a wall thickness of about 0.125 inches.

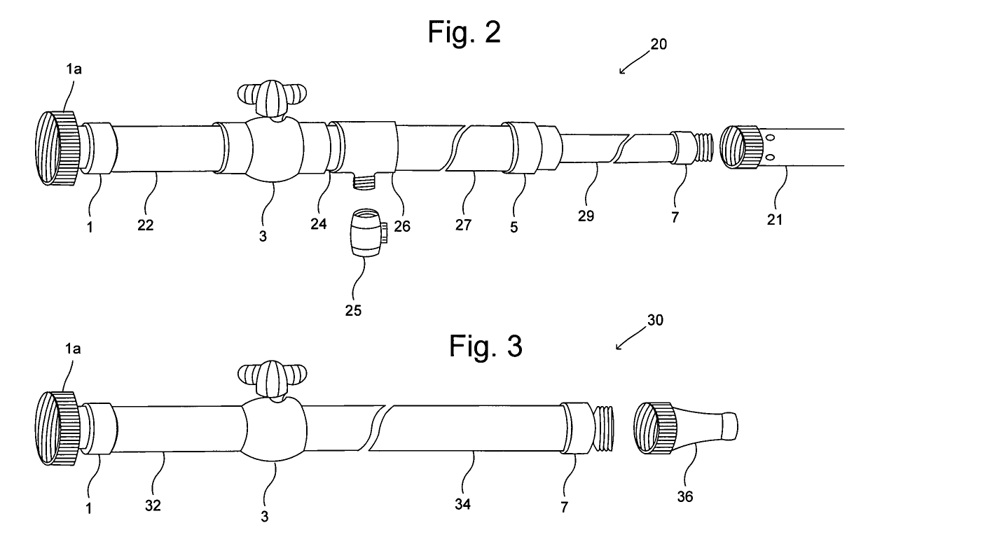

Long nozzle 20 depicted in FIG. 2 is similar to long nozzle 10 in FIGS. 1A and 1 B except that long nozzle 20 comprises a foam induction tee 26 and an air-aspirating foam nozzle tip 21. Long nozzle 20 comprises an adapter 1 with rotating hose-coupling device 1a. Connected to the adapter 1 is a first pipe 22. The ball valve 3 is positioned between the first pipe 22 and the second pipe 24. The foam induction tee 26 is attached to the second pipe 24 and comprises a threaded ball valve 25. A third pipe 27 is attached to the foam induction tee 26. A reducer coupling 5 is attached to the third pipe 27 on one side and to a fourth pipe 29 on the other side. A ferrule 7 with external threads is attached to the fourth pipe 29. Finally, long nozzle 20 comprises the air-aspirating foam nozzle tip 21 with internal threads.

The components of long nozzle are preferably made of thermoplastic and are preferably assembled by gluing. Alternatively, the components of the long nozzle 20 may be made of any other known material, including, but not limited to, anodized aluminum, brass, and fiber-reinforced plastic. The lengths, diameters and other dimensions of the individual components are variable. In this example, the long nozzle 20 is approximately 101.5 inches long. The first pipe 22, the second pipe 24 and the third pipe 27 each have an outside diameter of about 1.31 inches and a wall thickness of about 0.125 inches. The first pipe 22 is preferably about 12.5 inches in length, the second pipe 24 is preferably about 4 inches in length, and the third pipe 27 is preferably about 24 inches in length. The threaded ball valve 25 preferably has a diameter of about 0.75 inches. The fourth pipe 29 is about 40 inches in length and has an outside diameter of about 1.05 inches.

Long nozzle 30 depicted in FIG. 3 is similar in design to long nozzle 10 in FIGS. 1A and 1B except that the reducer coupling 5 has been removed and long nozzle 30 comprises an adjustable stream/fog nozzle tip 36. Long nozzle 30 comprises an adapter 1 with rotating hose-coupling device la. Connected to the adapter 1 is a first pipe 32. The ball valve 3 is positioned between the first pipe 32 and the second pipe 34. A ferrule 7 with external threads is attached to the second pipe 34. Finally, long nozzle 30 comprises an adjustable stream/fog nozzle tip 36 with internal threads.

The components of long nozzle are preferably made of thermoplastic and are preferably assembled by gluing. Alternatively, the components of the long nozzle 30 may be made of any other known material, including, but not limited to, anodized aluminum, brass, and fiber-reinforced plastic. The lengths, diameters and other dimensions of the individual components are variable. In this example, the long nozzle 30 is approximately 90.5 inches long. The first pipe 32 and the second pipe 34 each have an outside diameter of about 1.9 inches and a wall thickness of about 0.145 inches. The first pipe 32 is preferably about 13 inches in length and the second pipe 34 is preferably about 73 inches in length.

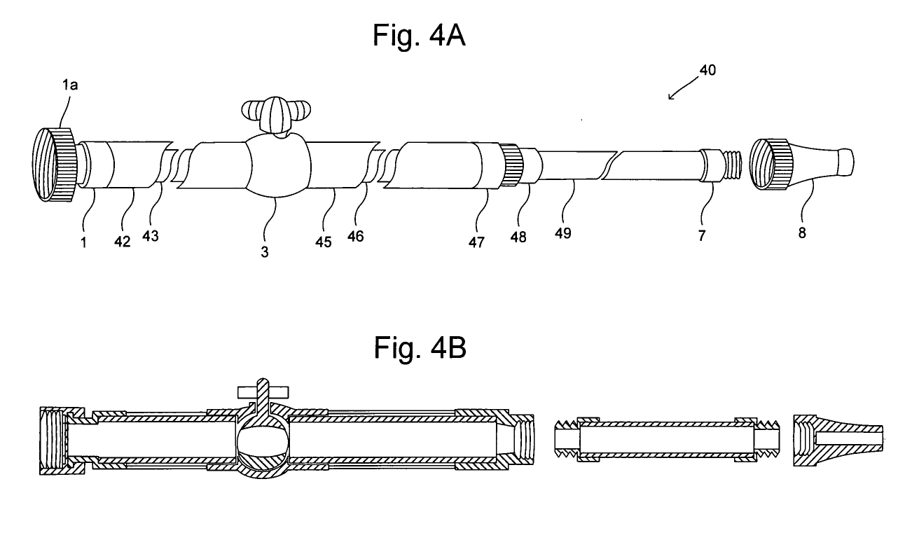

Long nozzle 40 depicted in FIGS. 4A and 4B is similar in design to long nozzle 10 in FIGS. 1A and 1B except that the first and second pipes comprise glass-fiber reinforced resin-based tubing. Long nozzle 40 comprises an adapter 1 with rotating hose-coupling device la. Connected to the adapter 1 is a first pipe 42 and tubing 43. The ball valve 3 is positioned between the first pipe 42, 43 and the second pipe 45, 46. A first adapter 47 is attached to the other side of second pipe 45, 46. A second adapter 48 is attached to first adapter 47. First adapter 47 has interior threads, while second adapter 48 has exterior threads. Third pipe 49 is attached to second adapter 48. A ferrule 7 with external threads is attached to the third pipe 49. Finally, long nozzle 40 comprises a tapered straight steam nozzle tip 8 with internal threads.

The components of long nozzle 40 are preferably made of thermoplastic and are preferably assembled by gluing. Alternatively, the components of the long nozzle 40 may be made of any other known material, including, but not limited to, anodized aluminum, brass, and fiber-reinforced plastic. The lengths, diameters and other dimensions of the individual components are variable. In this example, the long nozzle 40 is approximately 122 inches long. The first pipe 42 and the second pipe 45 each have an outside diameter of about 1.33 inches and a wall thickness of about 0.1 inches. The first pipe 42 is preferably about 16 inches in length and the second pipe 45 is preferably about 66 inches in length. Tubing 43 and tubing 46 each have an outside diameter of about 1.05 inches and a wall thickness of about 0.125 inches. Tubing 43 is about 18 inches in length and tubing 46 is about 68 inches in length. Third pipe 49 is about 30 inches long and has an outside diameter of about 1.05 inches and a wall thickness of about 0.125 inches.

Long nozzle 60 depicted in FIG. 6 is similar in design to long nozzle 20 in FIG. 2 except that the long nozzle 60 comprises a support leg 71. Long nozzle 60 comprises an adapter 1 with rotating hose-coupling device 1a. Connected to the adapter 1 is a first pipe 62. The ball valve 3 is positioned between the first pipe 62 and the second pipe 64. The foam induction tee 65 is attached to the second pipe 64 and comprises a threaded ball valve 66. A third pipe 67 is attached to the foam induction tee 65. The support leg 71 is attached to the third pipe 67 using a strap 69 with a bolt hole. The attachment end of the support leg 71 comprises a ferrule 70 with a bolt hole. The support leg 71 and the strap 69 are attached through the respective bolt holes using a bolt 72 and a nut 68. A reducer coupling 5 is attached to the third pipe 67 on one side and to a fourth pipe 74 on the other side. A strap friction catch 75 is attached to the fourth pipe 74. The friction catch 75 holds the support leg 71 adjacent to the long nozzle 60 when the support leg 71 is not in use. A ferrule 7 with external threads is attached to the fourth pipe 74. Finally, long nozzle 60 comprises an adjustable-stream nozzle tip 77 with internal threads.

The components of long nozzle 60 are preferably made of thermoplastic and are preferably assembled by gluing. Alternatively, the components of the long nozzle 60 may be made of any other known material, including, but not limited to, anodized aluminum, brass, and fiber-reinforced plastic. The lengths, diameters and other dimensions of the individual components are variable. In this example, the long nozzle 60 is approximately 154 inches long. The first pipe 62, the second pipe 64 and the third pipe 67 each have an outside diameter of about 1.66 inches and a wall thickness of about 0.14 inches. The first pipe 62 is preferably about 15 inches in length, the second pipe 64 is preferably about 5 inches in length, and the third pipe 67 is preferably about 80 inches in length. The threaded ball valve 66 preferably has a diameter of about 0.75 inches. The fourth pipe 74 is about 48 inches in length and has an outside diameter of about 1.31 inches. The strap 69 is preferably made of steel and is about 0.75 inches wide. The support leg 71 is preferably made of an aluminum tube with an outside diameter of about 0.75 inches and a length of about 56 inches. The strap friction catch 75 is preferably made of steel and is about 0.5 inches wide.

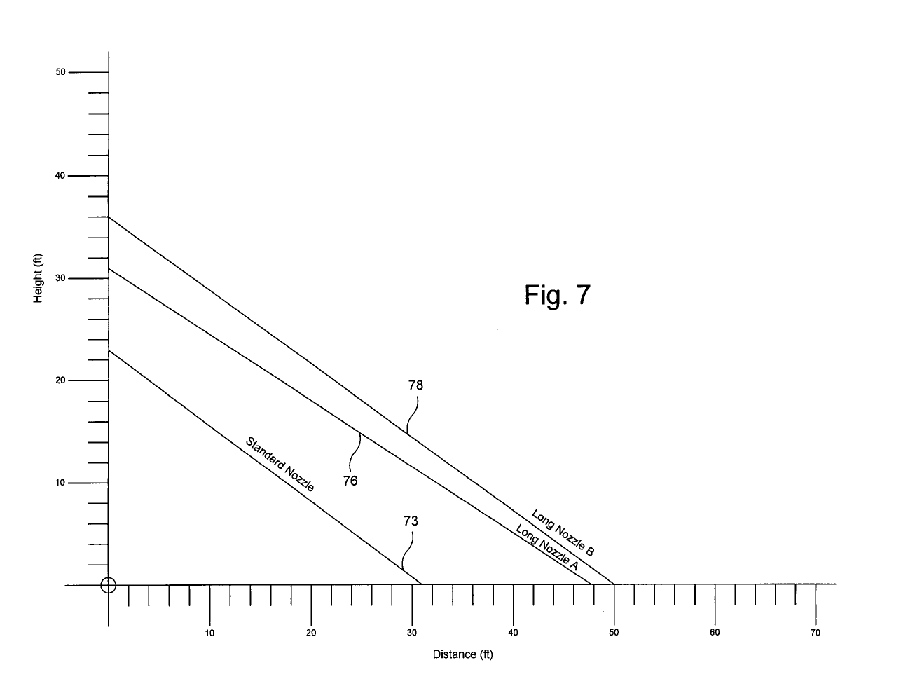

The additional stream reach of a fluid from a pressurized hose connected to the long nozzle exceeds the length of the long nozzle itself, as shown by the graphs in FIGS. 7-10.

The graph in FIG. 7 compares a standard nozzle to two different embodiments of the long nozzle of the present invention. In this example, the nozzles are all connected to an 8 gal/min foam kit. Line 73 represents the vertical height and horizontal distance data from a prior art nozzle. Line 76 represents data from long nozzle A and line 78 represents data from long nozzle B. Long nozzle A and long nozzle B are variations of the long nozzles depicted in FIGS. 1-6. In this example, long nozzle A is 69 inches long and has an outside diameter of 1.05 inches. Long nozzle B is 96 inches long and has an outside diameter of 1.05 inches. Clearly, the long nozzles of the present invention are able to achieve greater height and distance than the prior art nozzle. In this particular example, long nozzle A achieves a height improvement of about 8 feet and a distance improvement of about 17 feet over the prior art nozzle. Long nozzle B achieves a height improvement of about 13 feet and a distance improvement of about 19 feet over the prior art nozzle. Note that the height and distance improvements are much greater than the length of the nozzles. In addition, the data shows that a longer nozzle is preferable since long nozzle B was able to achieve greater height and distance than long nozzle A.

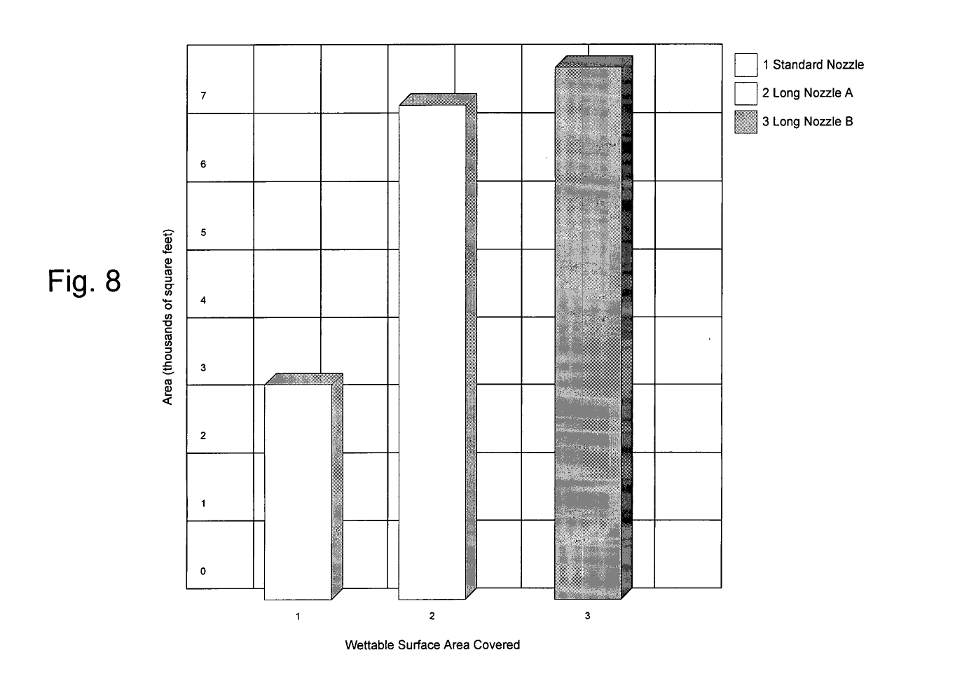

The chart in FIG. 8 depicts the data of FIG. 7 in terms of area covered. Clearly, the long nozzles cover more surface area than the prior art nozzle. In this particular example, Long nozzle A covers about 4,000 square feet more than the prior art nozzle and long nozzle B covers almost 5,000 square feet more than the prior art nozzle.

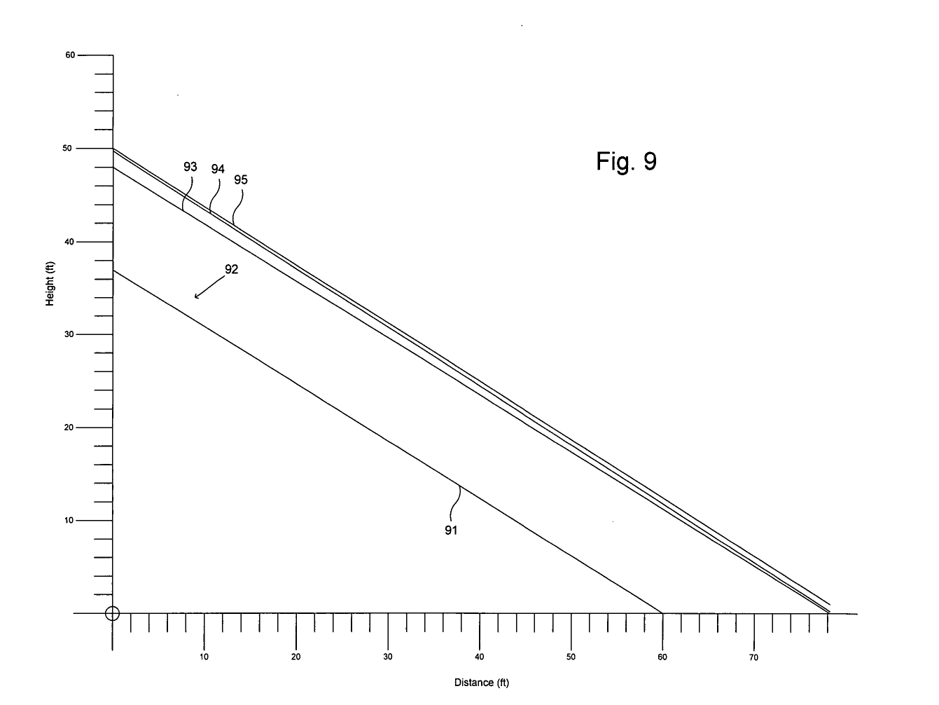

The graph in FIG. 9 compares standard nozzles to three different embodiments of the long nozzle of the present invention. In this example, the nozzles are all connected to a 90 psi water source. Line 91 represents the vertical height and horizontal distance achieved by a standard pistol nozzle. Line 92 represents the distance and height achieved by a standard straight-stream nozzle. Lines 93, 94 and 95 represent the distance and height achieved by long nozzles C, D and B, respectively. Long nozzles C, D and B are each attached to a straight-stream nozzle tip. In this example, long nozzle C is a variation of the long nozzles depicted in FIGS. 1-6. Long nozzle C is 96 inches long and has an outside diameter of 1.05 inches. Long nozzle D is depicted in FIGS. 1A and 1B. Long nozzle B is a variation of the long nozzles depicted in FIGS. 1-6. The dimensions of long nozzle B are given above in the discussion of FIG. 7. Clearly, the long nozzles of the present invention are able to achieve greater height and distance than the standard nozzles when used with water as well as foam.

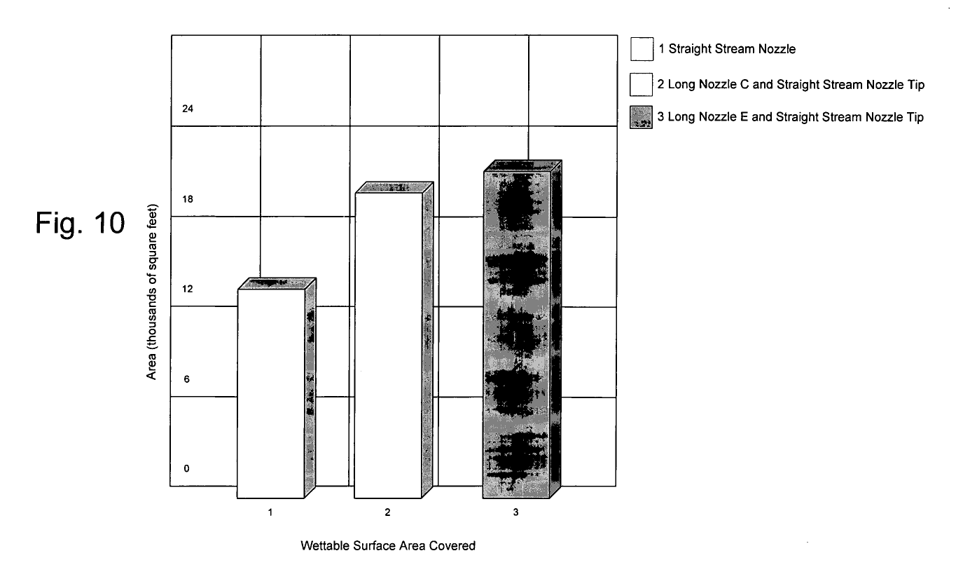

The chart in FIG. 10 depicts some of the data of FIG. 9 in terms of area covered. FIG. 10 shows that the long nozzles cover more surface area than the standard straight-stream nozzle. In this particular example, long nozzle C covers almost 6,000 square feet more than the standard straight-stream nozzle and long nozzle B covers about 7,500 square feet more than the standard straight-stream nozzle.

While the invention has been described by reference to the preferred embodiments described above those skilled in the art will recognize that the invention as described and illustrated can be modified in arrangement and detail without departing from the scope of the invention.

What is claimed is:

1. A nozzle for connection to a pressurized hose, comprising:
a hose-coupling device;
a first pipe with a first diameter;
a nozzle tip;
a nozzle aperture; and
a fluid acceleration zone,
wherein the fluid acceleration zone comprises a low friction area.

2. The nozzle according to claim 1, wherein an overall length of the nozzle is between 50 inches and 204 inches.

3. The nozzle according to claim 1, wherein a length of the low friction area is sufficient to reduce turbulence and friction near the nozzle aperture.

4. The nozzle according to claim 1, wherein the nozzle further comprises a ball valve.

5. The nozzle according to claim 1, wherein the nozzle further comprises a second pipe with a second diameter.

6. The nozzle according to claim 5, wherein the first diameter is different than the second diameter.

7. The nozzle according to claim 1, wherein the first diameter is between ⅜ inches and 3 inches.

8. The nozzle according to claim 5, wherein the second diameter is between ⅜ inches and 3 inches.

9. The nozzle according to claim 5, wherein the nozzle further comprises a reducer coupling used to connect the second pipe to the first pipe.

10. The nozzle according to claim 1, wherein the nozzle tip is a straight stream nozzle tip, an air-aspirating foam nozzle tip, or an adjustable stream/fog nozzle tip.

11. The nozzle according to claim 1, wherein the nozzle further comprises a foam induction tee.

12. The nozzle according to claim 11, wherein the nozzle further comprises a ball valve connected to the foam induction tee.

13. The nozzle according to claim 1, wherein the first pipe comprises glass-fiber reinforced resin-based tubing.

14. The nozzle according to claim 5, wherein the second pipe comprises glass-fiber reinforced resin-based tubing.

15. The nozzle according to claim 5, wherein the first pipe comprises glass-fiber reinforced resin-based tubing and the second pipe comprises glass-fiber reinforced resin-based tubing.

16. The nozzle according to claim 1, wherein the nozzle is made from one or more materials selected from the group consisting of plastics, composites and metals.

17. The nozzle according to claim 1, wherein each component of the nozzle is made from thermoplastic, anodized aluminum, brass, or fiber-reinforced plastic.

18. The nozzle according to claim 1, wherein the nozzle further comprises a support leg.

19. The nozzle according to claim 18, wherein the support leg is removeably attached to the nozzle.
